(19) United States
(12) Patent Application Publication
(10) Pub. No.: US 2004/0130781 A1
(43) Pub. Date: Jul. 8, 2004

(54) Image-forming methods of an optical microscope and an optical telescope

(76) Inventor: Katsuhiko Shinohara, Kakogawa-shi (JP)

Correspondence Address: Katsuhiko Shinohara, 669-20, Kimura, Kakogawa-choo, Kakogawa-shi, Hyogo, 675-0038, JP

(21) Appl. No.: 10/426,536

(22) Filed: May 1, 2003

(30) Foreign Application Priority Data
Jan. 7, 2003 (JP) 2003-48227

(51) Int. Cl. G02B 21/00; G02B 9/00; G02B 9/08

(52) U.S. Cl. 359/383; 359/738

(57) ABSTRACT

With the optical detection of a difference between both sides of a divided focus spot light of a section on a self-luminous body, the light from a light source point of said section on a self-luminous body is represented as a graph having a more peculiar point or a sharper point within the diffraction limit of the objective than the light intensity distribution graph of the focus spot light from said light source point of said section. With three values M, N and O from said optical detection of a difference in both sides of a divided focus spot light of said section on a self-luminous body, the brightness of a photo-image of said object on a self-luminous body is obtained by the value (M−2N+O).

### FIELD OF THE INVENTION

This invention relates to the image-forming methods of an optical microscope and an optical telescope with the effect of increasing the resolving power of their objectives.

### BACKGROUND OF THE INVENTION

Fluorescent microscopes are used to investigate the life-actions of cells, and astronomical telescopes are applied to make observations in astronomy.

Multi-photon laser-microscopes, used to observe the life actions of cells, obtain an optical image within the photo-diffraction-limit of their objective. However, there are few fluorescent materials used with multi-photon laser-microscopes.

Very large size astronomical telescopes are built in order to improve resolution. However, there is a limit to the improvement of the resolving power of an astronomical telescope due to the increasing cost of their construction and maintenance caused by gravity and the fluctuation of the atmosphere.

### SUMMARY OF THE INVENTION

The object of the present invention is to provide a method by which a fluorescent microscope, a fluorescent scanning microscope and an astronomical telescope can achieve improved resolving power.

In the image-forming methods of an optical microscope and an optical telescope, a phase diffraction grating with numerous sets of a bisected phase plates with π phase difference is installed at a focus plane of a section on a self-luminous body in order to achieve the above-mentioned goals.

The difference in photo-quantity of the light focus spot from it's light source point on said self-luminous body on the respective said bisected phase plate is obtained optically.

The said phase diffraction grating is scanned on the said focus plane of said self-luminous body.

The three values A, B and C of diffraction photo-quantity of said light focus spot on respective said bisected phase plate are detected at regular time intervals. Then, the value of (A−2B+C) indicates the brightness of the photo-image of that section of the said self-luminous body.

The two differentiated values D and E of said diffraction photo-quantity of said light focus spot on respective said bisected phase plate are detected at regular time intervals. Then, the value of (E−D) indicates the brightness of the photo-image of that section of the said self-luminous body.

The fluorescent scanning microscope in this invention installs a photo-detection system which optically detects said difference in the photo-quantity of the light focus spot on respective said bisected phase plates, from the said self-luminous body's fluorescence, returning back through the same irradiating optical system, as shown in FIG. 2, or installs said photo-detection system where the light beam is split into 2, with 1 light beam being inverted, and then detects the interference photo quality of the 2 light beams from said self-luminous body's fluorescence as shown in FIG. 3.

The three values G, H and I of said diffiraction or interference photo-quantities are detected by said photo-detection system in a regular time intervals. Then, the value of (G−2H+I) indicates the brightness of the photo-image in relation to the said self-luminous body.

The two differentiated values J and K of said diffraction or interference photo-quantities are detected by said photo detection system in regular time intervals. Then, the value of (K−J) indicates the brightness of the photo-image at the position corresponding to said self-luminous body.

### BRIEF DESCRIPTION OF THE DRAWINGS

FIG. 1 shows a block diagram for type astronomical telescope or for type fluorescent microscope of an embodiment.

FIG. 2 shows a block diagram embodiment for a fluorescent scanning microscope.

FIG. 3 shows another block diagram embodiment for a fluorescent scanning microscope.

FIG. 4 shows a block diagram embodiment for obtaining the improvement effect in two dimensional resolution.

FIG. 5 illustrates the method of obtaining the difference in the bisected focus spot light.

FIG. 6 shows a graph of the detected photo-quantity by a photo-detector from a light source point in a fluorescent scanning microscope.

FIG. 7 shows a differentiated graph of the detected photo-quantity by a photo-detector from a light source point in a fluorescent scanning microscope.

FIG. 8 shows a graph of the detected photo-quantity by a photo-detector from a light source point in an astronomical telescope or a fluorescent microscope.

FIG. 9 shows a differentiated graph of the detected photo-quantity by a photo-detector from a light source point in an astronomical telescope or a fluorescent microscope.

FIG. 10 shows a graph of the value (A−2B+C) obtained from graphs 33 and 35 at three positions in regular order or a graph of the value of (D−E) obtained from graphs 34 and 36 at two positions in regular order.

FIG. 11 illustrates the π/4 evaluation method of Rayleigh in this invention.

### DESCRIPTION OF THE PREFERRED EMBODIMENTS

An embodiment of the present invention is explained herein after referring to Figures.

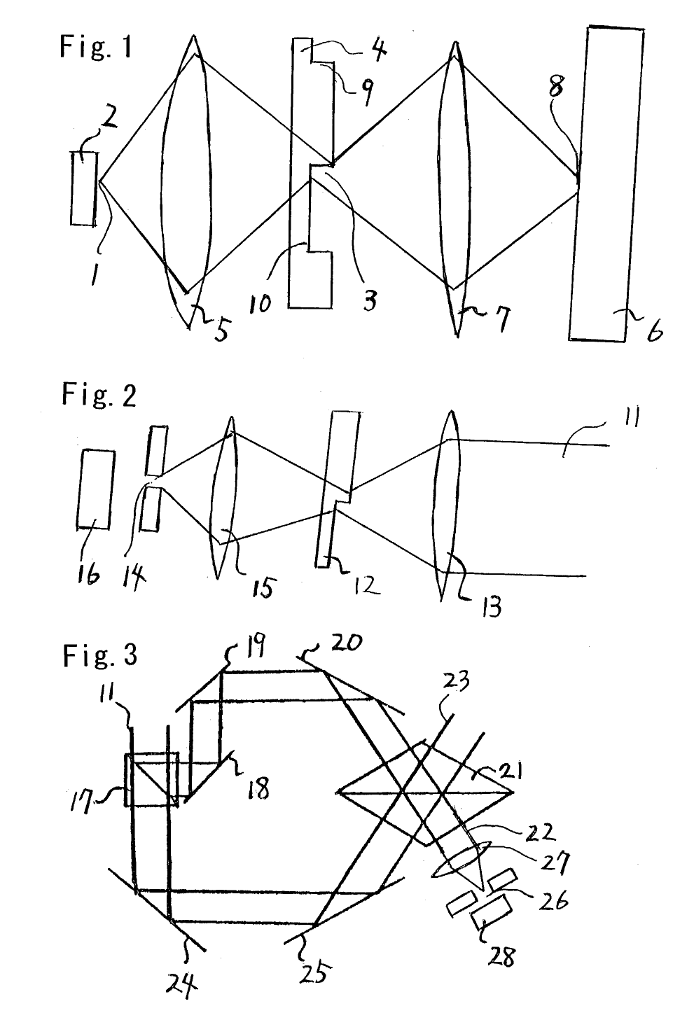

In FIG. 1, the light emitted from Point 1 on a self-luminous body 2 is focused on an area 3 with π phase level difference in a phase diffraction grating 4 through an optical system 5.

The diffracted light passing through the said area 3 is focused on the photo-detector surface of a two-dimension photo-detector 6 through an optical system 7 to a focus spot 8.

Three photo-quantities A, B and C at said focus spot 8 are detected at regular time intervals by the said two-dimension photo-detector 6.

The value of (A−2B+C) indicates the brightness of the photo-image of said Point 1 on said self-luminous body 2.

The value of (E−D) also indicates the brightness of the photo-image at said point 1 of said self-luminous body 2 when obtaining two differentiated values D and E of the detected photo-quantities at said focus spot 8 at regular time intervals.

A large number of areas 9,10 . . . have the same π phase level difference, so the brightness of the photo-images of said self-luminous body 2 corresponding to said areas 9, 10, . . . are obtained at the same time.

In a fluorescent con-focal scanning microscope as shown in FIG. 2, a fluorescent light beam 11 from said point 1 is turned into parallel light through an objective of said self-luminous body 2, and is focused on a phase diffraction grating 12 of a bisected plate with π phase difference through an optical system 13.

The diffracted light through said phase diffraction grating 12 is focused on a pinhole 14 through an optical system 15, and the light passing through said pinhole 14 is detected by a photo-detector 16.

In another embodiment in FIG. 3, said fluorescent light beam 11 is split into two by a beam splitter 17. One light beam is guided to a light deflector 18 where it is deflected from its course by said light deflector 18, and is guided to a light deflector 19, and is then guided to a light deflector 20, and is deflected from its course by said light deflector 20, and is guided to a beam splitter 21, and then is split into two light beams 22 and 23 by said beam splitter 21.

The other light beam resulting from said fluorescent light beam 11 being split, is guided to a light deflector 24, and is deflected from its course by said light deflector 24, and is then guided to a light deflector 25 where it is deflected from its course by said light deflector 25, and is guided to said beam splitter 21, and then is split into said two light beams 22 and 23 by said beam splitter 21.

Then, said light beam 22 is focused on a pinhole 26 through an optical system 27 and the light passing through said pinhole 26 is detected by a photo-detector 28.

The three values G, H and I of the photo-quantity are detected by said photo-detector 16 or 28 at regular time intervals. Then, the value of (G−2H+I) indicates the brightness of the photo-image of said Point 1 on said self-luminous body 2.

The two differentiated values J and K of said photo-quantity are detected by said photo-detector 16 and 28 at regular time intervals. Then, the value of (K−J) indicates the brightness of the photo-image of said Point 1 on said luminous body 2.

Conventional scanning microscopy can be performed by detecting said light beam 23, so that the fluorescent scanning microscope in this invention can easily investigate the targeted portion of said self-luminous body 2.

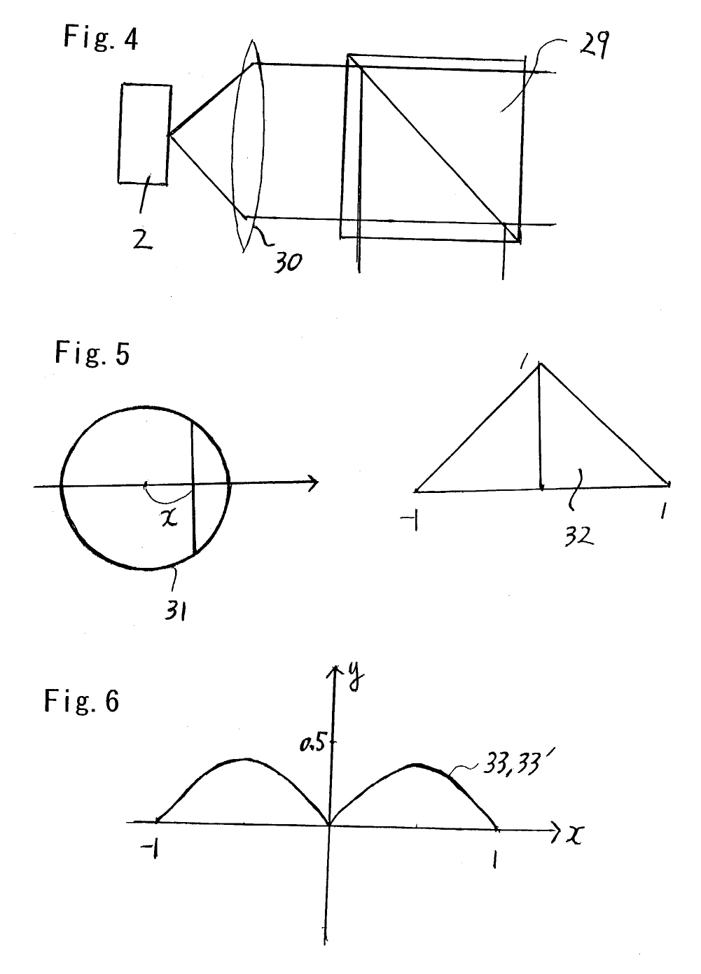

In FIG. 4, the light beam from said self-luminous body 2 is split into two by a beam splitter 29 after passing through the said optical system 30. Each of these two light beams is guided to FIG. 1 or FIG. 2 and then is focused on respective two phase diffraction gratings installed in a direction perpendicular to each other. Or each of these two light beams is guided to FIG. 3 and then is divided into two beams and interfere with each other with one beam inverted. These two inverted directions cross at right angles.

A fluorescent scanning microscope in FIG. 4 makes the image of the object of said self-luminous body 2 move in a direction oblique to the said respective two phase diffraction gratings with a π/4 angle or in a direction oblique to the said respective two inverted directions with a π/4 angle, thus resulting in higher resolution achievement in two directions in a direction perpendicular to each other at the same time because of the following explanations.

In FIG. 5, provided that a value of y is a value of the difference between both sides of said focus spot light 31 bisected at a position, distance x from the center of said focus spot light 31. and provided that the shape of the light-intensity distribution of said focus spot light 31 is shown as a cone with height 1 and with radius 1 at its bottom.

In the case 0≦x≦1

$$y = \frac{1}{3} π ( 1 - x ) - 4 ( 1 - x ) {\int }_{0}^{( 1 - x )} {\int }_{0}^{z} \sqrt{{( x + z )}^{2} - {( x + u )}^{2}} ⅆ x ⅆ u$$

In FIG. 6, a graph 33 showing an equation y is symmetrical about the y axis. Therefore, said graph 33 has a peculiar point or a very sharp point within the diffraction limit of the objective at the origin of the coordinate axes, and has a width of 2 and a height of about 0.5.

The graph showing the photo-quantity detected by said photo-detector 16 and 28 in FIGS. 2 and 3 respectively is shown as a graph 33′ almost similar to said graph 33 in FIG. 6.

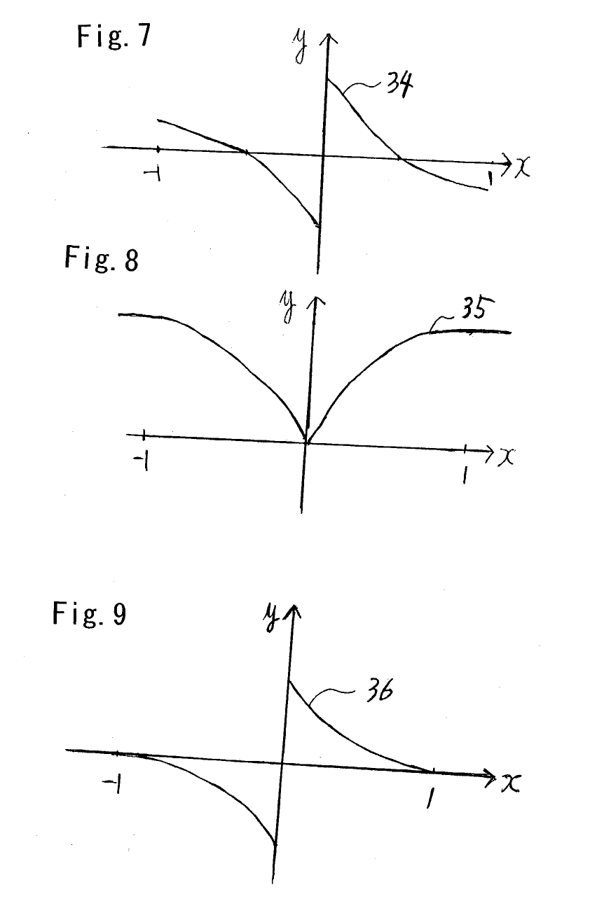

In FIG. 7, Graph 34 is obtained by the differentiation of said Graph 33′ in FIG. 6.

The graph showing the detected photo-quantity of said focus spot 8 in FIG. 1 is shown as Graph 35 in FIG. 8.

In FIG. 9, Graph 36 is obtained by the differentiation of said Graph 35 in FIG. 8.

Provided that three values A, B and C are obtained from said Graph 33′ and 35 at three positions in the x axis in a regular order. The value of (A−B) almost equals that of (B−C) when the sign (+/−) of the x-values are all the same, however, the value of (A−B) is very different from that of (B−C) when the signs (+/−) of the x-values are different.

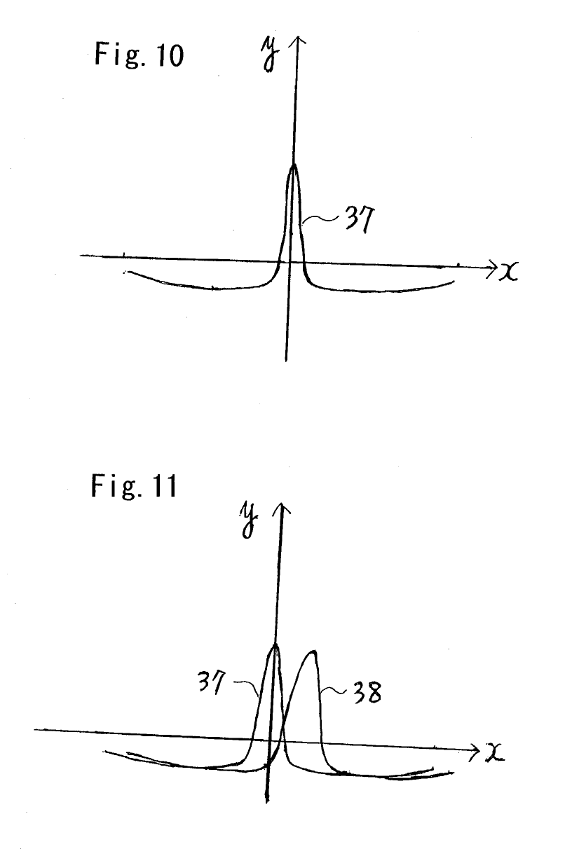

Therefore, in FIG. 10, a graph 37 of the value (A−2B+C) has a sharper peak than the light-intensity distribution graph of a focus spot light 31 when the x-value equals zero.

Provided that two values D and E are obtained from said graph 34 and 36 at two positions in regular order. The absolute value of (E−D) when the signs of the x-values are different, is larger than the absolute value of (E−D) when signs of the x-values are all the same.

Therefore, in FIG. 10, a graph 37 of the value of (E−D) has a sharper peak than the light-intensity distribution graph of the said focus spot light 31 when the x-value equals zero.

Since the light emitted from different points on the said self-luminous body 2 do not interfere with each other, the resolution limit can be explained by the λ/4 evaluation method of Rayleigh. In FIG. 11, the distance ‘d’ between two peaks of said graph 37 and 38 is less than a value of 1 explained by the λ/4 evaluation method of Rayleigh in a conventional microscopy, so resolving power in the direction of the x axis improves more than previously possible.

In FIGS. 7 and 9, said graph 34 and 36 are not connected in the position where the x-value equals zero, so they have differences in level at this position. Therefore, as shown in FIG. 10, the shorter the interval between said two positions in the x-axis from which we obtain said two values D and E, the sharper the peak of said graph 37 becomes.

Since this effect is produced in the direction of the x-axis, as explained in FIG. 4, the two optical images obtained from the two light beams into which the light from said self-luminous body 2 is split, are laid one on top of another.

In FIG. 1, when the light emitted from said point 1 on said self-luminous body 2 is focused on said area 3, said value of (A−2B+C) indicates the brightness of the photo image of said Point 1 on said luminous bady 2 and can be illustrated by Graph 37 in FIG. 10.

The λ/4 evaluation method of Rayleigh in FIG. 11 can be also explained by the relationship between said graph 37 and 38.

Since stray light, flares etc. focus widely on said phase diffraction gratings 4 and 12, the light intensity distribution graph obtained by said photo-detectors 6, 16 and 28 do not have any peculiar or sharp points.

Therefore, the image-forming method of an optical microscope and an optical telescope in this invention remove said stray light, flares etc. almost perfectly.

There is an embodiment where photo-detection-quantity is subtracted at regular time intervals and this operation can be repeated several times or not.

There is an embodiment where type reflection phase diffraction grating is used.

There is an embodiment that said phase diffraction gratings 4 or 12 or the equipment by which the light from a section on the said self-luminous body 2 is divided into two beams, with one beam inverted, that interfere with each other are rotated and/or the irradiating light beam scanning system is rotated or two sets of irradiating light beam scanning systems are installed in two directions and then the image of the section on the said self-luminous body 2 is obtained from computing the measurements at numerous positions during their rotation.

While a few embodiments of this invention have been illustrated and described in detail, it is particularly understood that the invention is not limited thereto or thereby.

What is claimed as:

1. Image-forming methods of an optical microscope and an optical telescope comprising: a photo-detection system which optically detects a difference in both sides of a divided focus spot light of an object on a self-luminous body; or a photo detection system in which the light beam from said object on a self-luminous body is divided into two that interfere with each other with one beam inverted; obtainment of measurements by said photo-detection system; the obtainment of a photo-image of said object on a self-luminous body from the values obtained through the operation with said measurements subtracted once or more.

2. Image-forming methods of an optical microscope and an optical telescope of claim 1, wherein 3 said measurements which we can call M, N and O which are detected by said photo-detection system at regular time intervals and the brightness of said photo-image of said section on a self-luminous body is obtained by the value (M−2N+O).

3. Image-forming methods of an optical microscope and an optical telescope of claim 1, wherein the two values P and Q are obtained by differentiating said measurements in said photo-detection system and said brightness of photo-image of said section on a self luminous body is obtained by the value (Q−P).

4. Image-forming methods of an optical microscope and an optical telescope of claim 1, wherein the rotation of the equipment which obtains optically a difference in both side of a divided focus spot light of the object of the said self-luminous body.

5. Image-forming methods of an optical microscope and an optical telescope of claim 1, wherein the rotation of the equipment by which the light from the object of said self-luminous body is divided into two beams, with one beam inverted, which then interfere with each other.

6. Image-forming methods of an optical microscope and an optical telescope of claim 1, wherein the rotation of the irradiating light beam scanning system.

7. Image-forming methods of an optical microscope and an optical telescope of claim 1, wherein the equipment of two sets of irradiating light beam scanning system in two directions.
